(19) United States
(12) Patent Application Publication
(10) Pub. No.: US 2010/0271173 A1
(43) Pub. Date: Oct. 28, 2010

(54) MANAGEMENT SYSTEM AND MANAGEMENT METHOD

(76) Inventors: Shinichiro AIKAWA, Fujisawa (JP); Masayuki Abe, Yokohama (JP); Kenichi Mizuishi, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/712,714

(22) Filed: Feb. 25, 2010

(30) Foreign Application Priority Data
Apr. 23, 2009 (JP) 2009-105476

(51) Int. Cl. G05B 19/00

(52) U.S. Cl. 340/5.52

(57) ABSTRACT

Provided is a management technology capable of ensuring adequate security management even when using finger vein authentication for restricting entry by specific workers to a controlled area and for limiting the use of apparatuses inside the controlled area. This invention is a system for managing authority of a worker to work in a controlled area that requires wearing of protective clothing. The system performs: personal authentication outside the controlled area, using biometric information of the worker when not wearing the protective clothing; and determination processing to determine, in the controlled area, whether or not the worker who has been authenticated has authority to work in the controlled area, using security information other than the biometric information.

### CROSS-REFERENCES TO RELATED APPLICATIONS

This application relates to and claims priority from Japanese Patent Application No. 2009-105476, filed on Apr. 23, 2009, the entire disclosure of which is incorporated herein by reference.

### BACKGROUND

1. Field of the Invention

The invention relates to a management system using biometric authentication technology. More specifically, it relates to a management system and a management method using biometric authentication technology for restricting entry to a controlled area requiring wearing of protective clothing.

2. Description of Related Art

Finger vein authentication and palm vein authentication have been practically used as technology for ensuring biometric authentication (for example, Japanese Patent Application Laid-Open Publication No. 2009-9354). These authentication technologies have been applied in a variety of fields, for example, personal identification upon computer management and withdrawal at banks.

However, employing these authentication technologies to restrict entry to controlled areas, such as clean rooms for semiconductor manufacturing processes, or to limit the use of apparatuses in the controlled areas makes accurate image pickup of vein patterns difficult as long as workers are wearing protective clothing, in particular, gloves.

On the other hand, lifting or relaxing restrictions on the use of apparatuses in the controlled areas because of the workers wearing protective clothing would sabotage adequate security management. Accordingly, there have been problems in that vein authentication technology cannot be used in security management for the type of controlled areas described above.

In order to solve the above problem, it is an object of this invention to provide a management technology capable of ensuring adequate security management even when using finger vein authentication for restricting entry by specific workers to a controlled area and for limiting the use of apparatuses in the controlled area.

### SUMMARY

In order to achieve the above object, this invention provides a management system for managing, using a management apparatus, authority of a worker to work in a controlled area that requires wearing of protective clothing. The management apparatus performs personal authentication outside the controlled area, using biometric information of the worker when not wearing the protective clothing; and determines whether or not the worker who has been authenticated has authority to work in the controlled area, using security information other than the biometric information which the worker can input, in the controlled area, to the management apparatus while wearing the protective clothing.

According to this invention, it is possible to provide a management technology capable of ensuring adequate security management even when using the finger vein authentication for restricting entry by specific workers to a controlled area and for limiting the use of apparatuses in the controlled area.

Other aspects and advantages of the invention will be apparent from the following description and the appended claims.

### BRIEF DESCRIPTION OF THE DRAWINGS

FIG. 1 is a block diagram showing an embodiment in which the management system of this invention is employed in a controlled area, which is a clean room for semiconductor manufacturing processes/gene manipulation.

FIG. 2 is a block diagram showing the details of the management system in FIG. 1.

FIG. 3 is a block diagram showing an example of a management table used by the management system.

FIG. 4 is a flowchart showing actions of the management server for prior registration of workers in the management server.

FIG. 5 is a flowchart of processing for personal authentication using a finger vein authentication technology.

FIG. 6 is a flowchart of processing for limiting access to a processing apparatus in the controlled area.

### DETAILED DESCRIPTION OF PREFERRED EMBODIMENTS

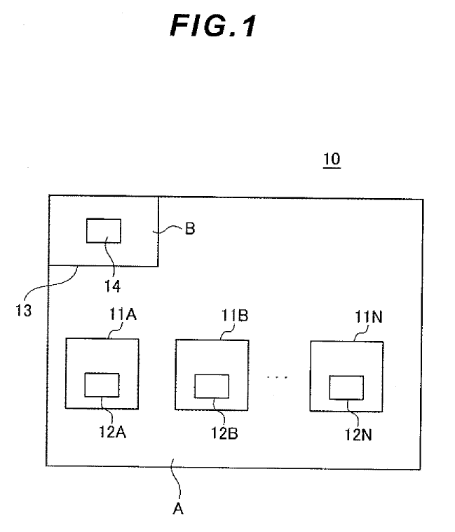

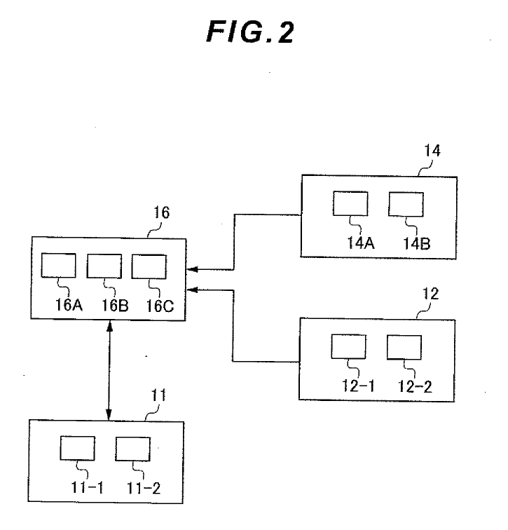

An embodiment of this invention will be explained below with reference to the attached drawings. FIG. 1 and FIG. 2 are block diagrams showing an embodiment having a clean room for semiconductor manufacturing processes/gene manipulation as a controlled area and employing the management system of this invention to restrict entry by specific workers to the clean room.

The management system 10 includes: first security apparatuses 12A, 12B, . . . 12N inside a clean room A; a second security apparatus 14 in a locker room B, which is a non-restricted area; and a management server 16.

The management server 16 is in charge of security processing for restricting entry by workers to the controlled area and for limiting the workers' access to processing apparatuses, based on information from the first security apparatuses 12A to 12C and information from the second security apparatus 14.

Processing apparatuses 11A to 11C are used by specific, skilled workers to execute predetermined processes under a special environment in the controlled area. For example, they are apparatuses for executing semiconductor manufacturing processes such as exposure and patterning for manufacturing semiconductors in the clean room, or apparatuses for executing gene manipulation processes such as gene recombination for manipulating genes in the clean room.

The example shown in FIG. 1 includes a plurality of processing apparatuses 11A, 11B, . . . 11N in the controlled area A. The processing apparatuses are provided with the first security apparatuses 12A to 12N, respectively.

Hereinafter, the reference numeral 11 is used when collectively referring to the processing apparatuses as a processing apparatus and the reference numeral 12 is used when collectively referring to the first security apparatuses as a first security apparatus.

Each first security apparatus 12 includes: an input circuit 12-1 to which a specific worker who is permitted to enter the controlled area A can input security information even when wearing protective clothing (at least gloves); and an output circuit 12-2 that outputs the input information to the management server 16. Examples of the security information include passwords which can be input via specified keys or identification codes such as information in non-contact type ID cards.

The second security apparatus 14 includes: an input circuit 14A to which the specific workers input finger vein information before putting on protective clothing; and an output circuit 14B that outputs the finger vein information to the management server 16. The input circuit 14A includes various types of optical elements for image pickup of the finger vein patterns.

Each processing apparatus 11 includes: an access right processing circuit 11-1 that executes access right processing in response to receiving access limitation information from the management server; and an output circuit 11-2 that obtains a log of accesses from a worker to an application program in the processing apparatus and outputs the access log to the management server 16.

The management server 16 includes: a determination circuit 16A that authenticates a specific worker and determines which processing apparatus and application in the processing apparatus the specific worker can access, based on identification code information sent from the first security apparatus 12 and finger vein pattern information sent from the second security apparatus 14; a management table 16B; and a processing unit 16C.

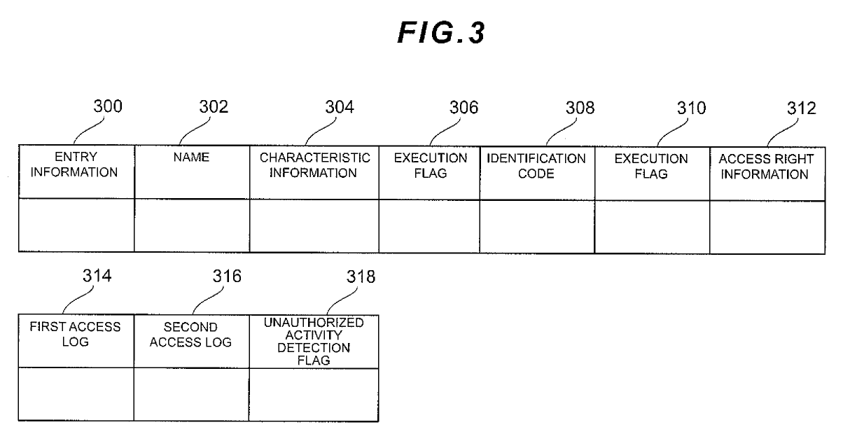

FIG. 3 is a block diagram showing the management table. The management table stores the following information: entry information 300 of a registered worker; a name 302 of the registered worker; characteristic information 304 of the finger vein pattern of the registered worker; an execution flag 306 related to personal authentication processing using the registered worker's finger vein; a password; an identification code 308, such as ID card information, of the registered worker; an execution flag 310 related to the identification processing based on the identification code; and access right information 312 of the registered worker.

The entry information 300 is automatically provided by the management server 16 when the worker registers in advance with the management server 16. The execution flag 306 relates to a result of the personal authentication of the registered worker executed by the determination circuit 16A in the management server 16 based on the information for the vein pattern input to the second security apparatus 14 and, when the personal authentication succeeds, the execution flag 306 is set to “1.”

An identification code applied in the first security apparatus is registered as the identification code 308 of the registered worker. When the determination circuit 16A in the management server confirms the identification code of a worker who applies for entry to the controlled area, it sets the identification execution flag 310 to “1.”The access right information 312 includes the ID of one or more processing apparatuses for which an access right has been granted to the registered worker; and the ID of one or more application programs the registered worker has a right to access. The registered worker can have access rights to all the application programs in all the processing apparatuses by registering, in the access right information field, management information corresponding to a predetermined value, for example, “all.”

The management table also includes: first access log information 314 which is the information in a log of accesses from the registered worker to the processing apparatuses and the application programs; and second access log information 316 which is the information in a log of accesses from the registered worker to the first security apparatus and the second security apparatus.

The management table further includes an unauthorized activity detection flag 318 which is set when the management server 16 detects an unauthorized activity by a specific worker. For example, when the management server 16 has not been recognizing any input of access log information from a processing apparatus for a predetermined period of time, it sets the fraud detection flag to “1.”

The management processing by the management system shown in FIG. 1 and FIG. 2 includes three stages: a first stage in which a specific worker previously registers his/her finger vein with the management server 16; a second stage in which the specific worker having entered the locker room B goes through the personal authentication process with the second security apparatus 14 using his/her finger vein before putting on protective clothing; and a third stage in which, in the controlled area, the use of certain processing apparatuses and the access to certain application programs are restricted when the specific worker intends so.

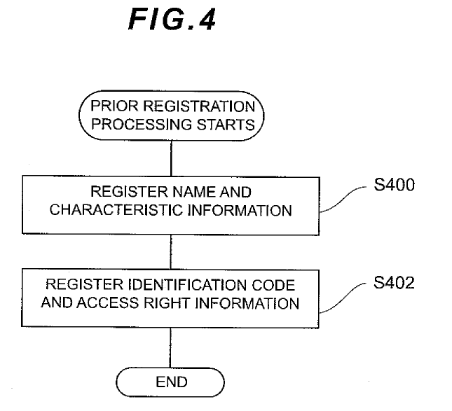

The details of the three stages will be explained with reference to the flowcharts. FIG. 4 is a flowchart showing actions of the management server 16 for prior registration of workers in the management server 16.

An administrator of the management server inputs a worker's name via an input device of the management server. The processing unit 16C in the management server obtains the worker's finger vein pattern via a finger vein pattern reading unit.

The processing unit 16C in the management server extracts characteristic information from the finger vein pattern and registers the characteristic information 304, entry information 300 of the registered worker, and a name 302 in the management table 16B (S400). The entry information 300 is automatically set by the processing unit 16C in each registration of a worker in the management table.

The administrator of the management server then registers, for each entry of the registered workers, an identification code 308 and access right information 312 in the management table 16B (S402). Thus completes the previous registration of the workers. As a result of this previous registration, the registered workers are recognized by the management system as specific workers who are permitted to enter the controlled area.

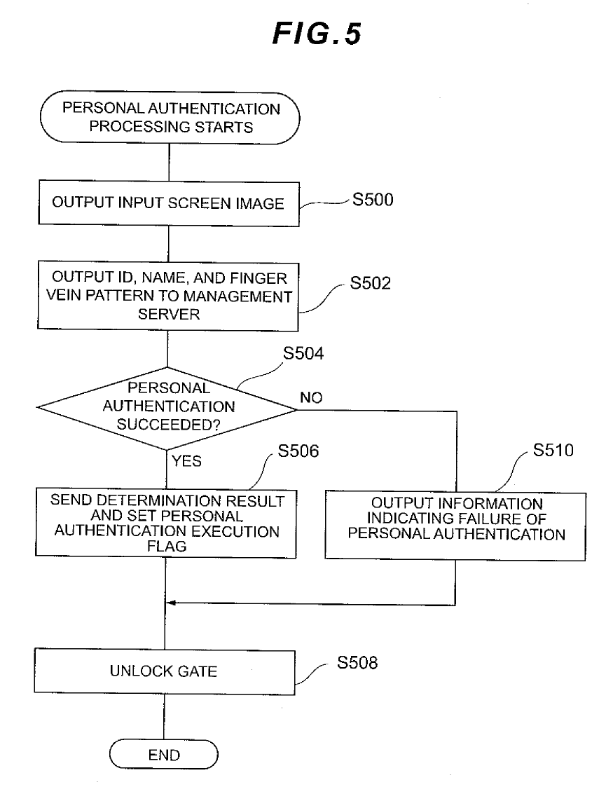

The content of the processing in the second stage, which is related to the personal authentication, will be explained with reference to the flowchart in FIG. 5. The second security apparatus 14 outputs, on a display unit, a screen image that prompts a specific worker to input his/her worker information (S500).

After the specific worker inputs, to the input circuit 14A in the second security apparatus 14, his/her registered worker ID and/or name and finger vein pattern, the output circuit 14B in the second security apparatus 14 outputs these information to the management server 16 (S502).

The processing unit 16C in the management server extracts the characteristic information from the finger vein pattern sent from the output circuit 14B and compares the characteristic information with the information registered in the management table 16B, thereby determining whether or not to authenticate the specific worker (S504).

When the registered worker ID and/or name matches up with the characteristic information of the finger vein pattern, the processing unit 16C determines that the personal authentication has succeeded and outputs the determination result to the first security apparatus 12 and the second security apparatus 14. It also outputs the result to the specific worker, sets the personal authentication execution flag 306 to “1” (S506) and unlocks a gate 13 between the locker room B and the controlled area A (S508). On the other hand, if the processing unit 16C judges that the personal authentication in step S504 has failed, it outputs that result (S510).

Incidentally, it is possible to omit locking the gate or allow unlocking of the gate as appropriate so that non-specific workers or maintenance persons can enter and leave the controlled area.

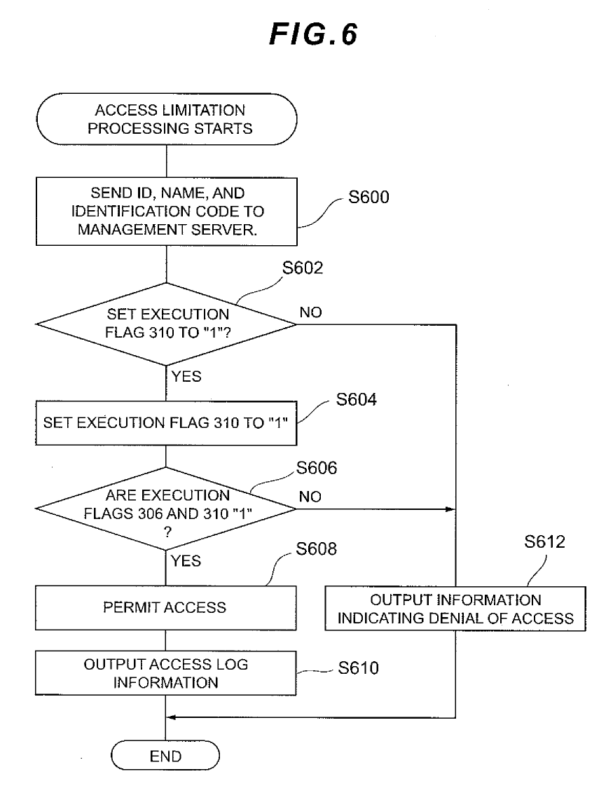

The content of the third stage related to the processing to limit access to the processing apparatuses in the controlled area will be explained below with reference to the flowchart in FIG. 6.

When the specific worker inputs—for example, by pressing a specified key or button—an access request to the first security apparatus 12 in a processing apparatus 11 the specific worker requests to access, the first security apparatus 12 prompts the specific worker to input his/her registered worker ID and/or name. The first security apparatus 12 then prompts the specific worker to input an identification code 308. This input information is sent to the management server 16 (S600).

The processing unit 16C in the management server compares the input information with the information stored in the management table 16B, determines whether or not the registered worker ID and/or name matches up with the identification code and, if it makes a positive determination, it sets the identification execution flag 310 to “1” (S602, S604).

Subsequently, the determination circuit 16A in the management server determines whether or not both the personal authentication execution flag 306 and the identification execution flag 310 are “1” (S606) and, if it makes a positive determination, it reads the access right information 312 from the management table 16B and outputs it to the access right processing circuit 11-1 in the relevant processing apparatus.

The access right processing circuit 11-1 permits, of the specific workers, the workers having relevant authority, to access the relevant processing apparatus and a specified application program, based on the access right information (S608).

The access log processing circuit 11-2 in the processing apparatus outputs, to the management server 16, the log of accesses from the authorized worker to the processing apparatus and the specified application program (S610). The management server registers this second access log information 316 in the management table. Incidentally, the management server registers, as the first access log information 314, the log of access to the first security apparatus and the log of access to the second security apparatus in the management table.

On the other hand, if the access right processing circuit 11-1 in the processing apparatus makes a negative determination in step S602, it outputs an access-denied message (S612). It then invalidates the access request from that specific worker.

When the specific worker leaves the controlled area, the specific worker takes off the protective clothing and inputs a request to leave the controlled area to the second security apparatus 14. This input includes inputting the finger vein information, the ID, and the name. When the second security apparatus 14 accepts the input, it resets the execution flags 306 and 310.

The determination circuit 16A in the management server continuously monitors the access log information 316—information in the log of accesses to the processing apparatus—in the management table 16B and, if it has received no access log information in a predetermined period of time and both the execution flags 306 and 310 have remained set at “1,” for example, when there is no request to leave the controlled area, the determination circuit 16A sets an unauthorized activity detection flag.

In the personal authentication processing shown in FIG. 5, when the second security apparatus checks and finds that an unauthorized activity detection flag has been set, it displays a warning message and prompts the specific worker to input a predetermined release code. If there is no input of the release code, the second security apparatus denies the personal authentication processing.

The aforementioned embodiment has been explained concerning a case in which the management server executes the processing for access rights to the processing apparatuses. However, it is also possible to have processing apparatuses execute the processing. Moreover, it is also possible to have the second security apparatus 14 extract characteristics of finger vein patterns and execute the personal authentication.

According to this invention, it is possible to employ biometric authentication technology for the processing for security for a controlled area that requires workers to put on protective clothing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A management system for one or more processing apparatuses located in a controlled area limiting entry to a specific worker and requiring the specific worker to wear protective clothing, comprising:
a first security apparatus including: an input circuit that allows the specific worker to input predetermined security information even when wearing the protective clothing; and an output circuit that outputs the security information;
a second security apparatus including: an input circuit with which the specific worker inputs biometric vein information outside the controlled area before putting on the protective clothing; and an output circuit that outputs the input vein information; and
a determination circuit for determining whether or not the specific worker has an access right to access any of the one or more processing apparatuses, based on the security information and the vein information.

2. The management system according to claim 1, wherein the determination circuit includes a circuit that extracts a characteristic pattern from the vein information, performs personal authentication for the specific worker based on the characteristic pattern, determines whether or not the specific worker, who has been authenticated and the security information of the specific worker having been judged valid, has an access right to access any of the one or more processing apparatuses and permits the specific worker to access the processing apparatus to which the specific worker has been granted the access right.

3. The management system according to claim 1, wherein the determination circuit determines whether or not the specific worker has an access right to access one or more specified application programs in the one or more processing apparatuses.

4. A method for managing, using a management apparatus, authority of a worker to work in a controlled area that requires wearing of protective clothing, wherein the management apparatus executes:
a first step of performing personal authentication outside the controlled area, using biometric information of the worker when not wearing the protective clothing; and
a second step of determining whether or not the worker who has been authenticated has authority to work in the controlled area, using security information other than the biometric information which the worker can input, in the controlled area, to the management apparatus while wearing the protective clothing.
